(19) United States
(12) Patent Application Publication
(10) Pub. No.: US 2016/0025413 A1
(43) Pub. Date: Jan. 28, 2016

(54) PIPE BUNDLE RECUPERATOR ON A SINTERING FURNACE AND THERMAL TRANSFER METHOD HAVING A SINTERING FURNACE AND HAVING A PIPE BUNDLE RECUPERATOR

(71) Applicant: GKN SINTER METALS ENGINEERING GMBH, Radevormwald (DE)

(72) Inventors: Eberhard Ernst, Eichenzell (DE); Thomas Schupp, Scheuerfeld (DE); Renè Albert, Motten (DE)

(21) Appl. No.: 14/777,114

(22) PCT Filed: Mar. 21, 2014
(86) PCT No.: PCT/EP2014/000775

§ 371 Date: Sep. 15, 2015

(30) Foreign Application Priority Data
Mar. 22, 2013 (DE) 10 2013 004 934.2

(51) Int. Cl. F27D 17/00; F28D 7/16

(52) U.S. Cl. CPC F27D 17/004; F28D 7/16; F27D 2017/007

(57) ABSTRACT

The invention relates to a pipe bundle recuperator on a sintering furnace for thermal transfer between at least one first fluid, a second fluid and a third fluid. The pipe bundle recuperator comprises the following: at least one first pipe bundle having a first pipe bundle entrance, a first pipe and a first pipe bundle exit for guiding the first fluid and at least one second pipe bundle having a second pipe bundle entrance, a second pipe and a second pipe bundle exit for guiding the second fluid, an outside pipe for guiding the third fluid, wherein the first pipe bundle and the second pipe bundle are arranged at least partially within the outside pipe, and, additionally, a fluid conducting system arranged in an interior region of the outside pipe for forced guidance of the third fluid along a course which is helical at least in regions, wherein the fluid conducting system has at least one first fluid conducting component. The invention further relates to a thermal transfer method having a sintering furnace and having a pipe bundle recuperator.

The invention relates to a pipe bundle recuperator on a sintering furnace. Further, there are proposed a thermal transfer method having a sintering furnace and having a pipe bundle recuperator.

It is an object of the invention to improve a sintering process to make it energetically more favorable.

The above object is achieved by a pipe bundle recuperator on a sintering furnace comprising the features defined in claim 1 and by a thermal transfer method having a sintering furnace and a pipe bundle recuperator comprising the features defined in claim 11. Further advantageous embodiments and modifications are evident from the following description. One or a plurality of features from the claims, the description and the figures can be combined with one or a plurality of features therefrom for obtaining further embodiments of the invention. Particularly, it is also possible to replace one or a plurality of features from the independent claims by one or a plurality of other features from the description and/or the figures. The proposed claims are to be interpreted only as a draft of its subject matter, however, without restricting it.

Proposed is a pipe bundle recuperator on a sintering furnace, for thermal transfer between at least a first fluid, a second fluid and a third fluid. Preferably, heat coming from the sintering furnace is used for heating at least the first fluid and/or the second fluid by transfer of thermal energy from the third fluid at least to the first fluid and/or the second fluid. The pipe bundle recuperator comprises:
at least one first pipe bundle having a first pipe bundle entrance, a first pipe and a first pipe bundle exit for guiding the first fluid, and at least one second pipe bundle having a second pipe bundle entrance, a second pipe and a second pipe bundle exit for guiding the second fluid,
an outer pipe for guiding the third fluid, wherein the first pipe bundle and the second pipe bundle are arranged at least partially within the outer pipe, and,
additionally, a fluid conducting system arranged in an interior region of the outer pipe (10) for forced guidance of the third fluid along an at least partially helical course, wherein the fluid conducting system has at least one first fluid conducting component.

The term “fluid” as used in the present description comprises gases, liquids, mixtures of gases and/or liquids, or gases and/or liquids, or also those gases, liquids or mixtures of gases and/or liquids that additionally comprise suspensions.

It can be provided that the first fluid, the second fluid and the third fluid have the same aggregation state. For instance, it can be provided that, during use of the pipe bundle recuperator, all of the first, second fluid and third fluids are gaseous. However, it can also be provided that e.g. the first fluid and the second fluid are liquid whereas the third fluid is gaseous. It can also be provided that, during use of the pipe bundle recuperator on a sintering furnace, the first fluid and/or the second fluid will change will change their aggregation state in the process of being heated. Particularly, such a change of the aggregation state could occur between the liquid aggregation state and the gaseous aggregation state. Further, it can be provided that the third fluid will change its aggregation state in the process of transfer of thermal energy from the third fluid to the first fluid and/or that the second fluid will change its aggregation state, particularly from the gaseous to the liquid state. However, also combinations of the above aggregation states or any other mixtures of aggregation states can be provided, such as e.g. a vapor phase as a heterogeneous mixture of a gaseous phase and one or a plurality of liquid and/or solid phases.

According to a preferred embodiment, the pipe bundle recuperator for thermal transfer between at least a first fluid, a second fluid and a third fluid is used for heating at least the first fluid and the second fluid by transfer of thermal energy from the third fluid to the first fluid and the second fluid.

The third fluid can be heated e.g. by heat from the sintering furnace, preferably, by waste heat of the sintering furnace. The first and second fluids can be used e.g. for the preheating of products that are to be sintered. For this purpose, the sintering furnace can e.g. comprise a preheating zone, with at least one of the two fluids flowing to the preheating zone and transferring heat to it. According to a further embodiment, it is provided that at least one of the two fluids, the first and/or the second fluid, is used for heating at least one further section independently from the sintering furnace.

According to a further embodiment, it can be provided that the pipe bundle recuperator for thermal transfer between at least a first, a second and a third fluid is used for cooling at least the first fluid and/or the second fluid by transfer of thermal energy from the first fluid and/or the second fluid to the third fluid.

The term “pipe” can denote, in a narrower sense, a pipe in the form of a longitudinal hollow body. A pipe can e.g. be understood to be a cylindrical hollow body. Particularly, the term “pipe” can denote pipes having a circular cross-sectional area, but there can be provided also embodiments having non-circular cross-sectional areas. Thus, for instance, use can be made of pipes having elliptic, rectangular or any other desired cross-sectional areas. Further, it is possible to use other designs of pipes differing from a cylindrical design. According to an embodiment having a particularly simple design, use is made of cylindrical pipes which at least in sections are formed as linear pipes while, according to other embodiments, it can be provided to use curved and/or winding pipes and/or pipes of other shapes. Particularly, it can also be provided that the term “pipe” in a wider sense comprises also pipe conduits which, apart from a number of one or a plurality of pipes, can also comprise further components, such as e.g. pipe fittings, expansion elements, seals, flanges, screw connections, bushings and the like.

The term “pipe bundle” denotes a unit of pipes which are combined in an assembly so as to form one unit. The pipes can be connected to each other in a detachable or non-detachable manner.

The term “fluid conducting component” denotes a component which, when the fluid conducting component is contacted by a fluid, will at least influence a movement of the fluid. Particularly, the fluid conducting component will influence the movement of a fluid flowing past it to the effect that the flow direction will be oriented corresponding to the geometry of the fluid conducting component. A fluid conducting component can be a plane plate or a curved plate, for instance. The term “fluid conducting system” denotes a totality of fluid conducting components, wherein a fluid conducting system comprises at least one first fluid conducting component. It can also be provided that the fluid conducting system comprises two or more fluid conducting components, wherein the fluid conducting components can be different from each other e.g. with respect to their constructional design, their material and/or their surface. In delimitation from the first pipe, the second pipe and the outer pipe, the fluid conducting component and fluid conducting components, respectively, and/or the fluid conducting system each are a component and respectively a totality of components arranged within the inner area of the outer pipe. Fluid conducting components, in contrast to a pipe, are not provided or suited for conducting a fluid independently but are designed for the purpose of effecting a forced guidance of a fluid flowing around the fluid conducting component and respectively the fluid conducting components.

The outer pipe can be formed e.g. as a pipe in the above described sense. Particularly, for instance, it can be provided that the outer pipe is formed as a cassette comprising two end sides and two longitudinal sides. This cassette can e.g. have a parallelepipedic shape. It can be provided that an entrance for an inflow of the third fluid into the pipe bundle recuperator is arranged in one of the two end sides and that an exit for an outflow of the third fluid from the pipe bundle recuperator is arranged in the other one of the two end sides. It is also possible, however, to arrange the entrance for the third fluid and the exit for the third fluid at the same longitudinal side or at different longitudinal sides of the pipe bundle recuperator. It is further possible to provide more than one entrance and/or more than one exit for the third fluid.

In its exemplary design as a parallelepipedic cassette, the outer pipe can comprise e.g. four plane plates, each being parallel the longitudinal extension of the outer pipe, which represent the four longitudinal sides. According to another embodiment, however, it can be provided that the outer pipe in its exemplary design as a parallelepipedic cassette comprises a plate which has been seamed for the purpose of forming four longitudinal sides, each being of a plane shape. However, one can also provide a corresponding arrangement of a different number of seamed or non-seamed plates for forming the longitudinal sides of the outer pipe designed as a parallelepipedic cassette.

Further, a plurality of cassettes can be arranged adjacent to each other, preferably in abutment with each other.

It is provided that a forced guidance of the third fluid takes place along a helical course. The term “helical course” is to be understood in the sense that, in an area where a forced guidance of the third fluid is effected by the fluid conducting system, a movement along this course can at least partially be described as a superposition of a directed movement along a straight line and of a movement running unidirectionally around this straight line. The component of the movement running around the straight line can e.g. be designed in such a manner that, in a projection onto a normal plane, it is represented as a movement corresponding to a circle, a spiral, an ellipse, a rectangle or an irregular figure. According to special embodiments, it can be provided that the helical course is configured as a course along a helix. At least in a part of the pipe bundle and/or in a section of the fluid conducting system, the course of the forced guidance is provided as a helical course. The term “helical course” can also include the case that the helical course according to the above definition is also superimposed by additional movement route lines and/or trajectories which generally occur during the flow of the third fluid. An advantage of the described design of the pipe bundle recuperator consists in the far-reaching optimization of the thermal transfer, e.g. in comparison to the thermal transfer which is normally reached by counterflow heat exchangers arranged in parallel connection.

According to one embodiment of the invention, it is provided that at least the first fluid conducting component comprises at least one recess which is formed as a pipe penetration for at least a first pipe and a second pipe. Further, it can be provided that the first pipe and/or the second pipe is guided through the pipe penetration. Further, it can be provided that the first pipe and/or the second pipe is bounded by the pipe penetration, i.e. is enclosed by it in a flush manner. The recess can be formed e.g. as a bore into which the first pipe and/or the second pipe is introduced. An advantage of introducing the first pipe and/or the second pipe into the pipe penetration of the first fluid conducting component resides e.g. in that the conducting of the third fluid by means of the fluid conducting component will at the same time also cause a flow around at least the first pipe. A further advantage of an arrangement of the first pipe and/or the second pipe in a pipe penetration of the first and/or the second fluid conducting component resides in that, in addition to an advantageous bypass conveyance of the third fluid past at least the first pipe and/or the second pipe, the pipes introduced into the recess and, as a possible result, the pipe bundle recuperator in its totality will be stabilized.

According to one embodiment of the invention, it is provided that the first pipe and/or the second pipe are oriented parallel to each other. Further, it can be provided that the first pipe bundle comprising at least the first pipe and the second pipe bundle comprising at least the second pipe are likewise oriented parallel to each other and that a plurality of pipes of the first pipe bundle or all pipes of the first pipe bundle and a plurality of pipes of the second pipe bundle or all pipes of the second pipe bundle, are oriented parallel to each other. A parallel arrangement of the largest possible number of pipes of the pipe bundle recuperator relative to each other has the advantage of allowing for a simple and at the same time compact design. Here, as well as in the entire description and in the claims, the term “parallel” is to be understood to be analogous to the mathematical description of a relative position of two straight lines to each other. On the other hand, the term “parallel” as used herein does not include an indication of a direction.

According to one embodiment of the pipe bundle recuperator, it can be provided that the first fluid conducting component comprises at least one plate. Designing the first fluid conducting component as a plate has the advantage, inter alia, that the constructional principle will allow for a simpler manufacturing process of the pipe bundle recuperator. A plate in the sense of the invention is not only a simple plane plate. It can also be a curved plate, for instance. Further, the plate can be one-layered or multi-layered. Particularly, it can be provided that the plate is a sheet of a metallic material. Particularly, the plate can be formed as a steel sheet. Further, alternatively or also additionally, the plate can comprise a different material. For instance, the plate can be coated, e.g. with a ceramic material.

According to one embodiment of the pipe bundle recuperator, it can be provided that the first fluid conducting component is arranged on at least one inner wall within the outer pipe.

For instance, the first fluid conducting component can be arranged on the inner wall within the outer pipe in a detachable or non-detachable manner.

According to one embodiment of the pipe bundle recuperator, it can be provided e.g. that one guiding plate or a plurality of guiding plates are arranged on support means mounted to an inner wall within the outer pipe and/or to the fluid separator. Said support means can be formed e.g. as angled pieces arranged on an inner wall within the outer pipe and/or on an inner wall within the outer pipe. Thus, for instance, it can be provided that the guiding plates are supported on said support means and are either not fastened or are fastened—in a detachable or non-detachable manner—to the support means.

In case that the first fluid conducting component is arranged on the inner wall within the outer pipe while not fastened in a non-detachable manner, it is advantageously possible to remove the first fluid conducting component from the pipe bundle recuperator, e.g. for cleaning purposes.

According to a further embodiment of the pipe bundle recuperator, it is provided that the fluid conducting system comprises at least a further, second fluid conducting component. Further, the pipe bundle recuperator comprises a fluid separator which is preferably formed as a plate. For instance, it can be provided that the fluid separator is formed as a curved plate. Thereby, it can be achieved e.g. that the fluid separator is bent around individual pipes.

It can also be provided, however, that the fluid separator is formed as a plane sheet-like plate. Particularly, this will offer the advantage of a very simple constructional design of the pipe bundle recuperator, with the resultant advantages of a simple and thus inexpensive manufacturing process and, possibly, also simple maintenance.

Further, it can be provided e.g. that the fluid separator is arranged between the first pipe and the second pipe.

According to a special embodiment, it can be provided that the fluid separator is arranged between the first pipe bundle and the second pipe bundle.

Further, it can be provided that the fluid separator is arranged between the first fluid conducting component and the second fluid conducting component. By an arrangement of the fluid separator between the first fluid conducting component and the second fluid conducting component, it is advantageously achieved that the third fluid can be forcibly guided along a helical course in such a manner that at least the first pipe and the second pipe, or—in arrangements comprising more than just these pipes—all pipes, will have the flow move around them at least approximately in a uniform manner, so that a thermal transfer from the third fluid to the first fluid and the second fluid as well as to other fluids possibly existing in further pipes can take place in a more uniform and efficient way.

It can also be provided that the fluid separator is arranged between the first pipe and the second pipe and the fluid separator is further arranged between the first fluid conducting component and the second fluid conducting component.

According to a further embodiment, it can be provided that the fluid separator is arranged in an area situated between the first pipe bundle and the second pipe bundle and that there will occur a reverse flow of the first fluid from an area of the first pipe bundle to an area of the second pipe bundle.

An arrangement of the fluid separator in an area situated between the first pipe bundle and the second pipe bundle has the effect that fluids will be conducted first past pipes of the first pipe bundle and then past pipes of the second pipe bundle or vice versa. By an arrangement of the first pipe bundle and the second pipe bundle as well as of the fluid separator in an interior area of the outer pipe and, at the same time, an arrangement of the fluid separator in an area situated between the first pipe bundle and the second pipe bundle, it is effected that fluids contained in the outer pipe, after having been conducted past the first pipe bundle, will be forced to move in reverse flow for the purpose of a subsequent flow past the second pipe bundle.

The described construction has proven to be particularly advantageous with respect to its handling. This can be favorable especially in case of a possibly required disassembly and later reassembly. The group-wise separation of the pipe bundles by the fluid separator also makes it possible to extend the helical course all the way to the level of the pipe bundle entrances and the pipe bundle exits or even beyond these.

Further, it can be provided that the first pipe bundle entrance and the second pipe bundle entrance are arranged on the same end of the outer pipe. In case of an arrangement of the first pipe bundle entrance and the second pipe bundle entrance on the same end of the outer pipe, it is effected that a first fluid contained in the first pipe bundle and a second fluid contained in the second pipe bundle will flow in the same direction or at least substantially in the same direction. A flow of the first fluid and the second fluid in the same direction or at least substantially in the same direction has the advantage of allowing for a particularly efficient transfer of thermal energy in the direction of a thermal equilibrium. In case of a sufficiently slow transport, it would be achieved or nearly achieved that the first fluid and the second fluid, when reaching the first pipe bundle exist and respectively the second pipe bundle exit, have the same or substantially the same temperature. The pipe bundle recuperator of such a design is advantageous e.g. in that, already by a very simple construction of the pipe bundle recuperator, it is possible to heat or cool different substance flows to the same desired temperature.

According to a further embodiment, it can be provided that the outer pipe has a rectangular or substantially rectangular cross section. The feature of at least substantially having a rectangular cross section is to be understood in the sense that the outer pipe, when viewed along the longitudinal dimension of the outer pipe, has at least in portions a cross section which is a rectangular cross section or nearly a rectangular cross section. The feature of a substantially rectangular cross section of the outer pipe further is to be understood in the sense that the substantially rectangular cross section exists at least in sectional view of the outer pipe vertically to the longitudinal extension of the latter. Rounded or oval corner are not contrary to the feature of having a substantially rectangular cross section. By a substantially rectangular cross section of the outer pipe, it is effected that the construction of the pipe bundle recuperator can be simplified. Thus, for instance, the construction of the pipe bundle recuperator can be designed such that the outer pipe of the pipe bundle recuperator consists of four plane plates forming the sheathing of the outer pipe.

A further idea of the invention which can be applied in connection with, or without connection with, the above described pipe bundle recuperator relates to a thermal transfer method having a sintering furnace and a pipe bundle recuperator.

Said thermal transfer method is a thermal transfer method having a sintering furnace and a pipe bundle recuperator, which method comprises thermal transfer between at least one first fluid, one second fluid and one third fluid. For instance, the first fluid and the second fluid can be conducted, at least along one section of the pipe bundle recuperator, in parallel to each other, wherein the third fluid, while flowing along a longitudinal section of the pipe bundle recuperator, is forcibly guided along a helical course by means of a fluid conducting system.

The term “helical course” in this context is to be understood in the above described sense.

According to a preferred embodiment, said thermal transfer method can be used for heating at least the first fluid and the second fluid by transfer of thermal energy from the third fluid to the first fluid and the second fluid by feeding a first fluid into the first pipe bundle and a second fluid into the second pipe bundle, wherein the first fluid and the second fluid have a lower temperature than the third fluid which is fed into the outer pipe.

Further, it can be provided that the third fluid is caused to flow around at least a pipe conducting the first fluid and/or at least a pipe conducting the second fluid.

Further, it can be provided that the flow around the pipes conducting the first fluid and/or the second fluid will cause an increase of the flow turbulence of the third fluid. Particularly, it can be provided that the number of pipes conducting the first fluid and/or the number of pipes conducting the second fluid per space unit is large enough to render the flow of the third fluid turbulent. An increase of the flow turbulence of the third fluid has the advantage that a thermal transfer from the third fluid to the first fluid and/or the second fluid can be achieve more efficiently. Thereby, particularly, also the efficiency of the thermal transfer can be enhanced. This is the case particularly because the increase of the flow turbulence will effect a largely uniform flow around the pipes conducting the first fluid and/or the second fluid.

Preferably, it is effected that all pipes arranged within the pipe bundle recuperator, preferably all pipes at least partially arranged within the outer pipe of the pipe bundle recuperator, have the third fluid flow around them in a uniform manner.

According to a further embodiment of the pipe bundle recuperator, it can be provided that the first fluid and the second fluid are guided substantially in the same direction.

According to a further embodiment of the pipe bundle recuperator, it can be provided that the third fluid has a directional component opposite to the direction of the flow of the first fluid and the second fluid. Thereby, the principle of the counterflow thermal transfer method is combined with the described thermal transfer method. Such an arrangement can have the advantage that the efficiency of the thermal transfer is increased.

Preferably, the thermal transfer method is used for heating the first fluid and/or the second fluid. This can be achieved in that the temperature of the third fluid at the entrance site of the third fluid into the heat exchanger is higher than the temperature of the first fluid at the first pipe bundle entrance and the temperature of the second fluid at the second pipe bundle entrance. According to a further idea of the invention, it is provided e.g. that at least a first fluid and a second fluid are heated by means of a sintering furnace exhaust gas flowing through the pipe bundle recuperator as a third fluid.

For instance, it can be provided that the thermal transfer method is used in connection with a sintering furnace in the form of a conveyer-type sintering furnace and that the third fluid is removed from the conveyer-type sintering furnace in an area of a transition zone situated between a preheating zone and a sintering zone. In this case, the third fluid can be e.g. a protective gas which will be introduced into the conveyer-type sintering furnace in an area of the sintering zone and will flow in the direction of the preheating zone and be heated. Apart from being heated, the protected gas will also be contaminated, e.g. by the particles evaporating during the sintering of the to-be-sintered parts.

Particularly, it can be provided that the thermal transfer method is designed as a preheating method. The provision of the thermal transfer method as a preheating method comprises particularly that the first fluid and/or the second fluid are gases and that these will be preheated for later use in a sintering furnace process, e.g. for the sintering of components in a conveyer-type sintering furnace.

However, it can also be provided to use the pipe bundle recuperator also with other given temperatures of fluids. For instance, it can be provided to heat a third fluid by a first fluid and/or a second fluid. It can be provided e.g. that the first fluid conveyed through the first pipe bundle and/or the second fluid conveyed through the second pipe bundle each have a higher temperature at the position of their entrance into the respective pipe bundle than the third fluid during its entrance into the pipe bundle recuperator. In case of such a provision, it can thus be provided e.g. to use the pipe bundle recuperator as a component of a refrigerating system.

Further advantageous embodiments and modifications are evident from the figures described hereunder. However, the details and features evident from the figures are not restricted to the latter. Instead, one or a plurality of features can be combined with one or a plurality of features taken from the above description so as to obtain new embodiments. Particularly, the following explanations are not intended to restrict the respective protective scope but are illustrative of individual features and their possible cooperation.

The figures show the following:

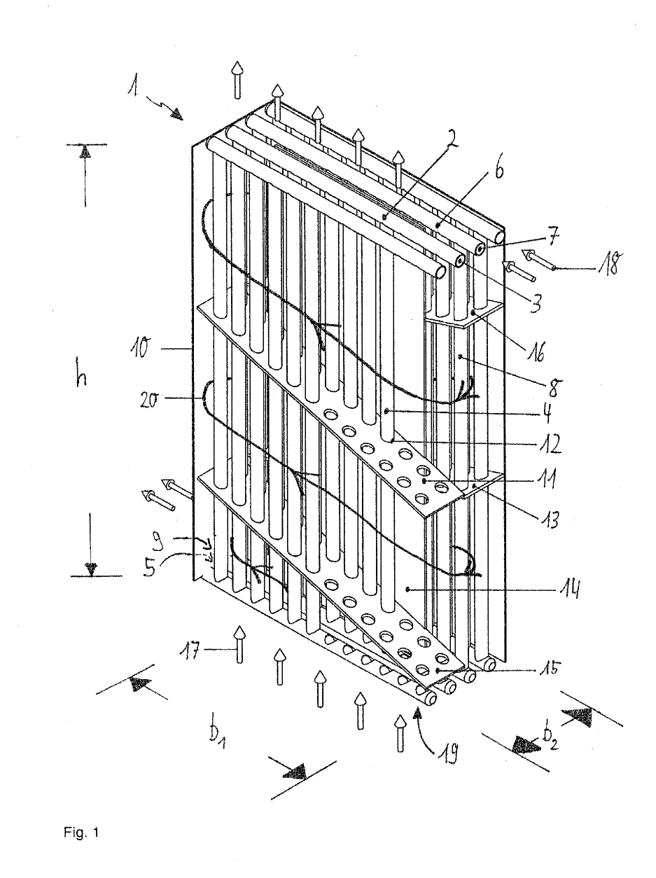

FIG. 1 a pipe bundle recuperator according to an exemplary embodiment in perspective view,

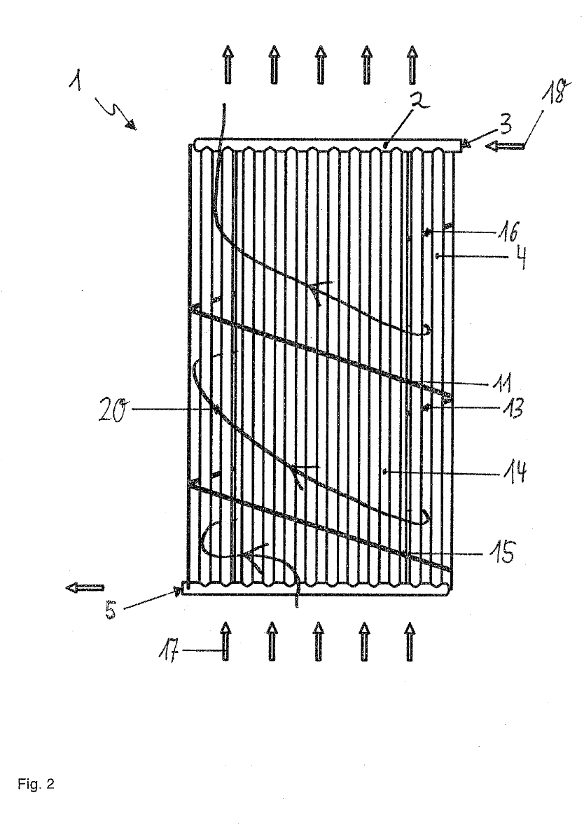

FIG. 2 a pipe bundle recuperator in lateral view,

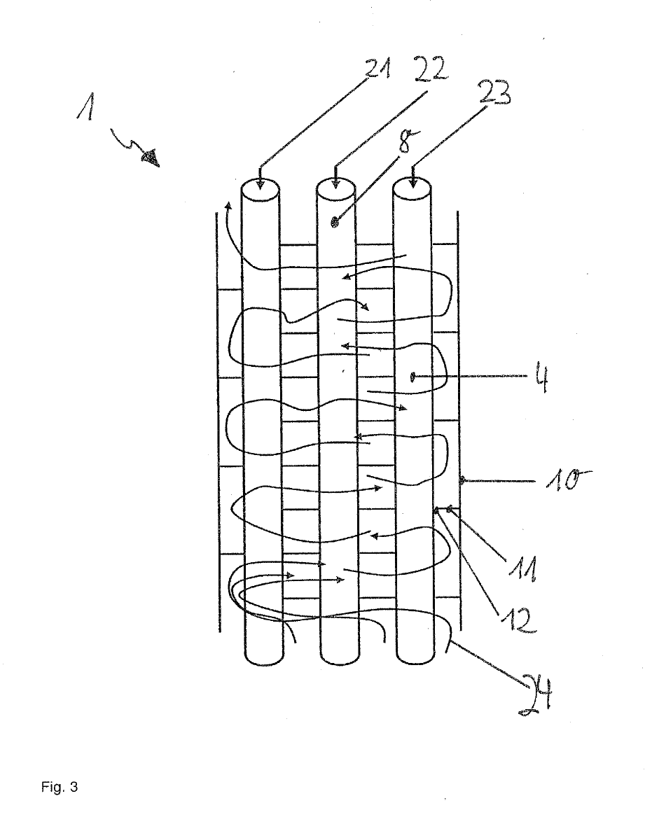

FIG. 3 a further embodiment of the pipe bundle recuperator in lateral view,

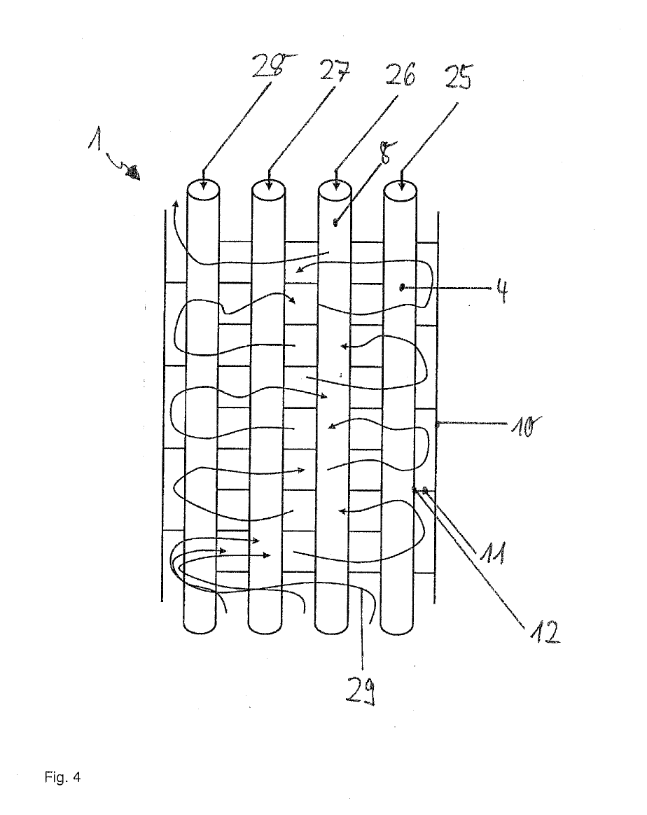

FIG. 4 a further embodiment of the pipe bundle recuperator in lateral view,

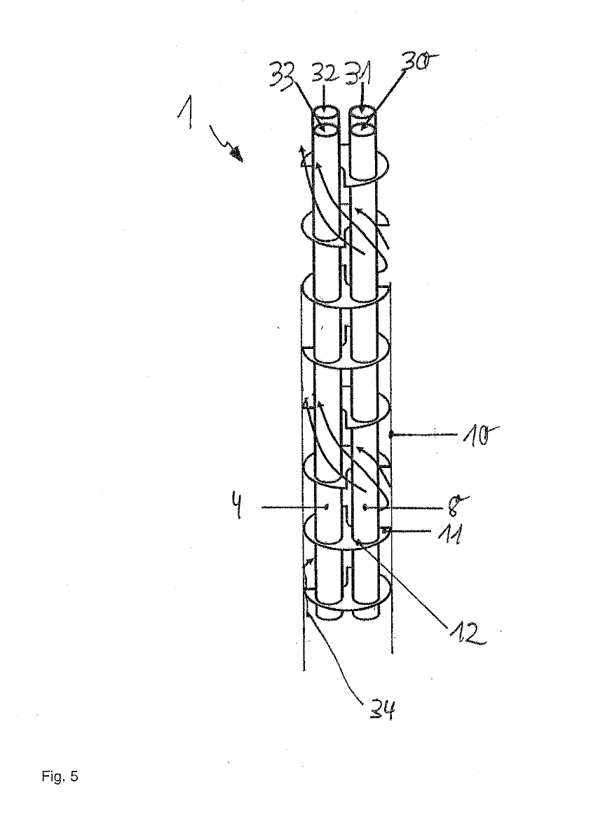

FIG. 5 a further embodiment of the pipe bundle recuperator in lateral view,

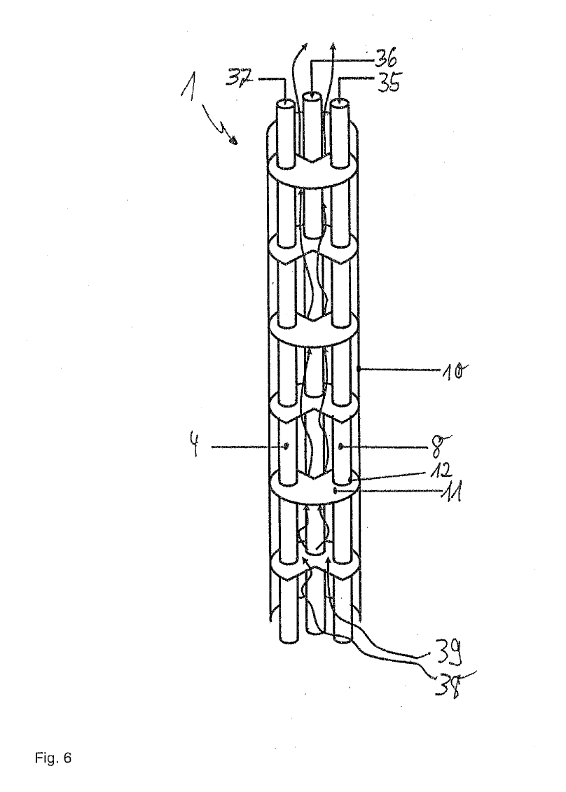

FIG. 6 a further embodiment of the pipe bundle recuperator in lateral view.

In FIG. 1, there is shown a pipe bundle recuperator 1 according to one embodiment, comprising a total of four pipe bundles. The pipe bundle recuperator is delimited by an outer pipe 10 which in the illustrated embodiment is formed as a cassette consisting of four plates oriented vertically relative to each other, wherein, in the present view, only two of these plates are shown. The height h of the outer pipe in the present view of the pipe bundle recuperator 1 is larger than the dimensions b₁ and b₂.

It can be provided e.g. that the height h has an amount in the range from 200 mm to 10,000 mm, preferably from 500 mm to 2,500 mm, and with particular preference an amount from 1,900 to 2,100 mm. According to one embodiment, it can be provided that the height h has an amount of 2,000 mm.

Further, it can be provided that the dimension b₁ has an amount in the range from 100 mm to 2,000 mm, preferably from 500 mm to 1,500 mm, and with particular preference an amount from 700 to 900 mm. According to a special embodiment, it can be provided that the dimension b₁ has an amount of 800 mm.

Further, it can be provided that the dimension b₂ has an amount in the range from about 50 mm to about 1,000 mm, preferably from about 100 mm to about 500 mm, and with particular preference an amount from 150 to 250 mm. According to a special embodiment, it can be provided that the dimension b₂ has an amount of 200 mm.

A first pipe bundle 2 and a second pipe bundle 6 are separated from each other by a fluid separator 14 formed as a plane plate and as a central partition wall, wherein the fluid separator 14 along the longitudinal extension of pipe bundle recuperator 1 is at least as long as, or longer than, said longitudinal extension. The width dimension of fluid separator 14 is smaller than the width dimension b₁ of outer pipe 10 so that the fluid separator 14 does not end at the lateral walls of outer pipe 10. On both surfaces of fluid separator 14, a first fluid conducting component 11 and a second fluid conducting component 13 are arranged. The first fluid conducting component 11 and the second fluid conducting component 13 are e.g. arranged on the pipe bundle recuperator 1 in such a manner that both the first fluid conducting component 11 and the second fluid conducting component 13 are oriented vertically to fluid separator 14.

In a sense of rotation encircling the flow direction 17 in a clockwise manner, the first fluid conducting component 11 and the second fluid conducting component 13 in cooperation with fluid separator 14 form a helical course. Along this helical course, a fluid and respectively fluid flows which exist within the pipe bundle recuperator 1 and outside the pipe bundles and have been introduced into the pipe bundle recuperator 1 via the outer pipe opening 19, will be forcibly guided. Such a forcible guidance takes place because the dimension of the fluid separator 14 along the width dimension of the outer pipe 10 of pipe bundle recuperator 1 is smaller than the dimension of the outer pipe 10 of pipe bundle recuperator 1. Due to this difference in dimensions, openings are generated between the lateral edges of the fluid separator and the inner surfaces of the outer pipe, which openings are effective to generate, near the lateral walls of the pipe bundle recuperator which in the illustrated embodiment are oriented vertically to fluid separator 14, a reverse movement of the third fluid within at least one corridor which includes e.g. also the trajectory 20. In general, however, the trajectory 20 is not identical with the course of the flow of the third fluid. Instead, a flow of the third fluid is possible within a corridor including the trajectory 20 and being delimited by the inner walls of pipe bundle recuperator 1 and the fluid conducting components as well as the fluid separator 14. Apart from the overriding flow direction of the third fluid as represented by the trajectory 20, also flows in other directions are possible, wherein particularly a turbulent flow is possible which is enhanced by the pipe bundles arranged within outer pipe 10.

The first pipe bundle 2 comprises a first pipe bundle entrance 3 adapted for inflow of a first fluid.

It can be provided e.g. that said first pipe bundle entrance has a diameter in the range from about 8 mm to about 300 mm, preferably from about 10 mm to about 100 mm, and with particular preference an amount from 20 to 50 mm.

The above mentioned amounts of the diameter of the first pipe bundle entrance can also be typical values provided for further first pipe bundle entrances and/or first pipe bundle exits.

Further, the first pipe bundle 2 comprises twelve pipes, all of them extending parallel to each other and at the same time parallel to all outer walls of pipe bundle recuperator 1 from their start in the direction of a manifold leading to a first pipe bundle exit 5. Said twelve pipes comprise a first pipe 4.

It can be provided e.g. that said first pipe has a diameter of an amount in the range from about 8 mm to about 300 mm, preferably from about 10 mm to about 100 mm, and with particular preference an amount from 20 to 50 mm.

The first pipe 4 passes through the first fluid conducting component 11 by being completely surrounded by a recess 12 formed as a bore and, in the illustrated embodiment, being even bounded by said recess. By the fact that, in the illustrated embodiment, the first pipe and all further pipes are bounded by recesses of the fluid conducting component, it is e.g. achieved that a fluid flow through the recesses of the fluid conducting components is largely avoided. Further, in the illustrated embodiment of the pipe bundle recuperator 1, the fluid conducting components are dimensioned in such a manner that, at each of their four edges, the fluid conducting components terminate in abutment with the inner surface of outer pipe 10. By this abutting termination of the fluid conducting components with inner surfaces of outer pipe 10 and by the fact that the first pipe 4 and all further pipes are bounded by recesses of fluid conducting components, it is achieved that the forced guidance of the third fluid in the helical course will take place with maximal efficiency. Further, according to other embodiments of the pipe bundle recuperator 1, it can be provided that one or a plurality of the fluid conducting components do not terminate flush with one or a plurality of the inner walls within outer pipe 10 and/or that one or a plurality of recesses do not bound the respective pipe which is to be passed through them, but that, instead, the recess has a larger surface area than the cross section of the pipe at the position of this recess. Discharge of the first fluid takes place via the pipe bundle exit 5 which is not visible in FIG. 1.

It can be provided that the fluid conducting components in a pipe bundle recuperator 1 comprising an outer pipe 10 formed as a cassette include, together with the end sides, an angle in the range from 5 degrees to 60 degrees, preferably from 10 degrees to 30 degrees, and with particular preference from 15 degrees to 25 degrees.

According to one embodiment, this angle can be in the range from 17.5 degrees to 20 degrees.

Particularly, it can be provided that the slope of the fluid conducting components, i.e. the angle enclosed by a fluid conducting component and the end sides, is identical for all fluid conducting components of a recuperator.

In the illustrated embodiment, the second pipe bundle 6, the second pipe bundle entrance 7, the second pipe 8 and the second pipe bundle exit 9 are provided in an analog manner to the first pipe bundle 2, the first pipe bundle entrance 3, the first pipe 4 and the first pipe bundle exit 5 and thus have the same design. The second pipe 8 as well as the other eleven pipes of the second pipe bundle 6 are enclosed by a recess formed in the second fluid conducting component 13. Together with further fluid conducting components 15,16, the first fluid conducting component 11 and the second fluid conducting component 13 in cooperation with the fluid separator 14 and the outer pipe 10 form a system for forced guidance of a third fluid which in the illustrated exemplary embodiment will enter the pipe bundle recuperator 1 along the arrows 17. The second fluid will enter the second pipe bundle 6 along arrow 18 via the second pipe bundle entrance 7 while the first fluid will enter the first pipe bundle 2 via the first pipe bundle entrance 3.

In FIG. 2, a similar pipe bundle recuperator 1 as in FIG. 1 is shown in lateral view. By the representation in lateral view in FIG. 2, particularly also the course of the trajectory 20 is clearly visible which is an example of a design of a helical course.

In FIG. 3, a further embodiment of a pipe bundle recuperator 1 is shown in lateral view. As has been the case in the embodiments of a pipe bundle recuperator shown in FIG. 1 and FIG. 2, the embodiment of a pipe bundle recuperator shown in FIG. 3 comprises, apart from an outer pipe 10, a first pipe 4 of a first pipe bundle, a second pipe 8 of a second pipe bundle as well as a third pipe of a further pipe bundle. Further, the pipe bundle recuperator comprises a fluid conducting system wherein there are provided a fluid conducting component 11 as well as other fluid conducting components as plane plates which along the longitudinal extension of the pipe bundle recuperator 1 are respectively offset relative to each other and are formed vertically to the walls of outer pipe 10. The pipe bundle recuperator 1 in the illustrated embodiment comprises a fluid separator, not shown in FIG. 3, which is arranged in a plane behind the illustrated fluid conducting components but does not separate a first pipe bundle from a second pipe bundle. The three illustrated pipes belong to three different pipe bundles into which is introduced, along the illustrated arrows 21, 22 and 23, a respective fluid in the form of a substance flow At the lower end of the pipe bundle recuperator, there is introduced, along arrow 24, a third fluid which has a movement component opposite to the direction extending along arrows 21, 22 and 23. Within the outer pipe, the third fluid will flow, in a helical course, around the three pipes containing the fluids flowing along the illustrated arrows 21, 22 and 23, thus effecting an optimum thermal transfer between the third fluid and said fluids contained in the pipes.

FIG. 4 shows a further embodiment of a pipe bundle recuperator 1 according to FIG. 3. The view of the pipe bundle recuperator shown in FIG. 4 is different from the embodiment shown in FIG. 3 particularly in that, within the outer pipe 10, four parallel pipes are arranged as components of different pipe bundles so that four different substance flows, flowing along respective ones of the arrows 25, 26, 27 and 28, will perform a heat exchange with a third fluid flowing along a corridor in which the trajectory 29 is situated.

FIG. 5 shows a further embodiment of a pipe bundle recuperator 1. The pipe bundle recuperator shown in FIG. 5 comprises, by way of example, four pipes arranged within an outer pipe 10, inter alia a first pipe 8 and a second pipe 4 which in the illustrated view are assigned to four different pipe bundles. Into the four pipes arranged within the outer pipe, four different fluids, provided as substance flows, will be introduced along the arrows 30, 31, 32 and 33. A further, third fluid, provided as substance flow, will be introduced in the opposite direction into the pipe bundle recuperator, along a guide in which the trajectory 34 is situated. Within outer pipe 10, there is further arranged a fluid conducting system comprising fluid conducting components which, as fluid conducting components designed as plane plates substantially in the form of a three-quarter circle, are arranged within the outer pipe. Within the fluid conducting components, as evident also from fluid conducting component 11, a recess 12 is provided having the second fluid 8 arranged in it. The totality of the fluid conducting components forms a fluid conducting system. In the embodiment of a pipe bundle recuperator shown in FIG. 5, all visible fluid conducting components have the same shape and are arranged in parallel orientation relative to each other in such a manner that a line passing through the center of each of the fluid conducting components forms a straight line that is parallel to the boundary of the outer pipe. Each of the fluid conducting components is rotationally offset relative to the respective next fluid conducting component by an angle of 90 degrees, wherein the direction of the rotation remains identical along the longitudinal axis of the pipe bundle recuperator. By this design, there is caused a forced guidance of the third fluid along a helical course. In consequence, this has the effect that the third fluid will be guided in the best uniform manner past all of the pipes arranged within the outer pipe, thereby allowing for a very good transfer of heat between the third fluid and the fluids within the pipes.

The embodiment of a pipe bundle recuperator 1 shown in FIG. 6 is similar to the embodiment shown in FIG. 5 in that also the embodiment of a pipe bundle recuperator 1 shown in FIG. 6 comprises an outer pipe 10 having a circular cross section. However, apart from the first pipe 4 and the second pipe 8, the pipe bundle recuperator shown in FIG. 6 comprises only one further pipe. As a feature shared with the pipe bundle recuperator shown in FIG. 5, it is provided also in the pipe bundle recuperator shown in FIG. 6 that each of the pipes arranged within the outer pipe is assigned to another pipe bundle. The design of each fluid conducting component, as also of the fluid conducting component 11, is similar to the design of the fluid conducting components of the pipe bundle recuperator shown in FIG. 5. In the pipe bundle recuperator 1 shown in FIG. 6, other than in the pipe bundle recuperator 1 shown in FIG. 5, the fluid conducting components forming a fluid conducting system are rotationally offset relative to each other not by 90 degrees but by 180 degrees. Particularly also in cooperation with the pipes, it is provided also in this embodiment of the fluid conducting system that a fluid conducted within the outer pipe around the pipes arranged within the outer pipe undergoes a forced guidance. By way of example, a forced guidance of a third fluid introduced into the lower opening takes place along contours represented by the arrows 38 and 39. Also this embodiment will result in a very uniform flow around the pipes arranged within outer pipe 10 and, thereby, a good transfer of heat from the third fluid to the first fluid, the second fluid and the fourth fluid which are conducted along the arrows 35, 36 and 37 in a respective one of the pipes within outer pipe 10.

1. A pipe bundle recuperator for thermal transfer between at least a first fluid, a second fluid and a third fluid, preferably for heating at least the first fluid and the second fluid by transfer of thermal energy from the third fluid to the first fluid and the second fluid, wherein the pipe bundle recuperator is arranged on a sintering furnace, said pipe bundle recuperator comprising:
at least one first pipe bundle having a first pipe bundle entrance a first pipe and a first pipe bundle exit for guiding the first fluid, and at least one second pipe bundle having a second pipe bundle entrance, a second pipe and a second pipe bundle exit for guiding the second fluid,
an outer pipe for guiding the third fluid, wherein the first pipe bundle and the second pipe bundle are arranged at least partially within the outer pipe, and,
additionally, a fluid conducting system arranged in an interior region of the outer pipe for forced guidance of the third fluid along an at least partially helical course, wherein the fluid conducting system has at least one first fluid conducting component.
wherein the third fluid is a flowing sintering-furnace exhaust gas.

2. The pipe bundle recuperator according to claim 1, wherein at least the first fluid conducting component comprises at least one recess formed as a pipe penetration for at least the first pipe.

3. The pipe bundle recuperator according to claim 1, wherein the first pipe and the second pipe are oriented parallel to each other.

4. The pipe bundle recuperator according to claim 1, wherein the first fluid conducting component comprises a preferably plane plate.

5. The pipe bundle recuperator according to claim 1, wherein the first fluid conducting component is arranged on at least one inner wall within the outer pipe.

6. The pipe bundle recuperator according to claim 1, wherein the fluid conducting system comprises at least one further, second fluid conducting component and that the pipe bundle recuperator comprises at least fluid separator preferably formed as a plate and said fluid separator
is arranged between the first pipe and the second pipe and/or
is arranged between the first fluid conducting component and the second fluid conducting component.

7. The pipe bundle recuperator according to claim 6, wherein the fluid separator is arranged in an area located between the first pipe bundle and the second pipe bundle and that a reverse flow takes place from a section of the first pipe bundle to a section of the second pipe bundle.

8. The pipe bundle recuperator according to claim 1, wherein the first pipe bundle entrance and the second pipe bundle entrance are arranged on the same end of the outer pipe.

9. The pipe bundle recuperator according to any one of claim 1, wherein the first pipe bundle entrance and the second pipe bundle entrance are arranged on opposite ends of the outer pipe.

10. The pipe bundle recuperator according to claim 1, wherein the outer pipe has a rectangular, substantially rectangular, oval or circular cross section.

11. A thermal transfer method having a sintering furnace and a pipe bundle recuperator, particularly a pipe bundle recuperator according to claim 1, said method comprising thermal transfer between at least one first fluid, one second fluid and one third fluid, preferably for heating at least the first fluid and the second fluid by transfer of thermal energy from the third fluid to the first fluid and the second fluid, wherein the first fluid and the second fluid are conducted separately from each other and, at least along one section, parallel to each other, and wherein the third fluid, while flowing along a longitudinal extension of the pipe bundle recuperator, is forcibly guided by means of a fluid conducting system substantially along a helical course.

12. The thermal transfer method according to claim 11, wherein the third fluid has a directional component opposite to the direction of the flow of the first fluid and the second fluid.

13. The thermal transfer method according to claim 11, wherein the third fluid is caused to flow around at least a pipe conducting the first fluid and/or at least a pipe conducting the second fluid.

14. The thermal transfer method according to claim 11, wherein a flow around said pipes conducting the first fluid and/or the second fluid is effective to cause an increase of a flow turbulence of the third fluid for a largely uniform flow around said pipes conducting the first fluid and/or the second fluid, preferably around all of the pipes arranged within the pipe bundle recuperator.

15. Use of a pipe bundle recuperator on a sintering furnace for heating at least a first fluid and a second fluid, preferably by application of a thermal transfer method according to claim 11, by means of a sintering furnace exhaust gas flowing through the pipe bundle recuperator as a third fluid.
